(19) United States
(12) Patent Application Publication
(10) Pub. No.: US 2010/0033047 A1
(43) Pub. Date: Feb. 11, 2010

(54) Flavell home electric generation system

(76) Inventor: Herbert George Flavell, Hallstead, PA (US)

Correspondence Address: Herbert G. Flavell, R R 2 Box 2279, Hallstead, PA, 18822-9618, US

(21) Appl. No.: 12/215,022

(22) Filed: Aug. 5, 2008

(51) Int. Cl. H02K 47/04; H02K 7/18; H02K 53/00

(52) U.S. Cl. 310/113; 290/4 A; 415/916

(57) ABSTRACT

A self generating home electric system. Started by a portable generator that powers the first motor that then belt drives a generator head. That generator head then supplies 240 volts power to a second motor that then belt drives a second generator head. The second generator head will then supply 240 volts power to a third motor that then belt drives the third generator head. The third generator head then sends 240 volts power to motor four. Motor four now takes over from motor one to belt drive generator head one.

Three generator heads are now supplying 240 volts electric to three motors allowing the portable generator and motor one to shut down. Motor one will stop automatically when the portable generator is stopped. Generator head one will then be supplying 120 volts electric to a buildings wall outlets. While generator head two supplies 120 volts electric to a buildings lighting and other utilities like electric stove, washer, dryer, compactor, water heater, well and septic pumps. Generator head three will be supplying 240 volts of electric to power a homes electric baseboard heat system. Other motors and generators can be added to this system for larger buildings like schools, stores and factories. There is no need for present art batteries to start and run this system. Even the portable generator is recoil starting.

### RELATED APPLICATIONS

This application is a correction submitted on Jun. 6, 2008. application Ser. No. 12/215,022.

### PRIOR ART

Prior art until my invention used fossil fuels, atomic power, solar, wind, water, steam, fuel cells and batteries. All had disadvantages. Fossil fuels depleted our natural resources. Atomic power created atomic waste that would last for thousands of years. Solar and wind generation was only good if there was bright light or a good wind. Solar energy could not be created at night leading to the use of storage batteries that required lead be mined and battery acid be created. These also lead to polluting our land with lead and acid. Wind energy was a hazard to wildlife and people living nearby. Water and steam generation called for huge dams and power generation plants which made electric expensive. This power also called for wires to deliver the electric power long distances. Because of these long distances, the power could be interrupted by storms or natural disasters causing thousands of families to be without power for days or weeks. Using my invention requires no batteries. The machines used in this system can be bought now off the shelf for about $5,000, add a $2,000 profit for the manufacturer and you have a home electric generation system that the average homeowner could pay off in 3 years using the savings from having no electric or heat bills. Another advantage of this system is, when a component motor or generator head stops working. The component can then be re-manufactured for use again. By re-ferbing the motors and generator heads more natural resources are saved and landfills are not polluted with batteries as in prior art. There are about 130 million homes in the USA. If this system was installed in every home in the USA, over the years it would save homeowners thousands of dollars in fuel for heat costs and monthly electric bills. The manufacturer would at a $2000 profit on each system, make nearly $260 billion dollars producing a product that can be made and used today.

I look at this system as I did my first car a 1935 Chevy. Cars today have improved greatly since then. More horsepower, automatic transmissions and faster speeds. The same with my invention, in 73 years I can see bigger and better power generation using this system. This invention could also be installed underground in areas that are tornado prone. Homes built in these areas could have tornado shelters built underground and connected by a passageway from the basement to a sleeping room connected to the generator room. Because this invention produces no fumes it would be safe for inhabitants.

After reading about the prior art, I wonder why none of these inventions are in use today. Some of these patents date back to 1978. Now for the systems use in a car. There are electric cars today but they require batteries. They also only have a range of 40 or 50 miles, then have to be plugged in overnight to recharge. Using my invention, the car would never stop for fuel until it was stopped by the driver. The car would then be restarted on less than a cup full of gas or natural gas used by the startup generator that will be shut down after the generators are generating electric to the drive motors. This car would then be saving billions of gallons of gas and oil for other transportation that cannot use electric ie trucks, and planes. Ships also would be difficult to electrify, but not impossible because during WW2 submarines ran submerged under electric power that required batteries. Someday even those maybe able to use electric from my invention.

### LIST OF PRIOR ART RECEIVED FROM LITMAN LAW.

US 2002/0036483 A1

US 2002/0114985 A1

US 2003/0102752 A1

US 2007/0296221 A1

US 2007/0296276 A1

U.S. Pat. No. 4,182,960 1980

U.S. Pat. No. 5,432,383 1995

U.S. Pat. No. 7,228,841 B2

U.S. Pat. No. 7,309,300 B2

EP 0 734 113 A2

JP 2002-142386 & 142386A & JP 2003-174764

### BACKGROUND OF THE INVENTION

The field of the invention is related to a home electric generation system that needs no outside electric provided by previous art of nuclear, water, solar, wind, water or steam generation. A need has been identified by me to rid the world of electric generated by fossil fuel, wind, water, solar, steam and nuclear. This system will supply electric using inventions that can be purchased now. This home electric generation system will eliminate the monthly electric and heating bills. This system if installed in every home in the USA would cut oil, natural gas, propane and coal by 50% or more. There would also be no blackouts from power loss caused by ice, wind, accidents or natural disasters. Power loss would happen only if a component failed. But ⅔ of the system would still work until the failed component was repaired or replaced by an electrician. The system would then be restarted using the portable electric generator. For larger homes, more motors and generator heads could be added. The adding of motors and generator heads is limitless and the system could be adapted to manufacturing plants, apartments, hospitals, schools and stores. There would be no further need for atomic, wind, solar, fossil fueled, water or steam generated power. There would never again be thousands of homes without power for weeks due to natural disasters. Nor would there be deaths due to running portable generators while the electric was down. Gone also would be terrorists opportunities to knock out power by destroying power plants. If this system were adapted to cars, the car could run from L.I., N.Y. to California and back on its own electric without stopping to recharge and at no cost for fuel.

### BRIEF SUMMARY OF THE INVENTION

A/ This invention is a Home Electric Generation System. No outside electric is needed to run this system. This electrical generation system uses machines that have previously been invented but uses them more efficiently. The system is started by a portable electric generator that produces 240 volts of electric. That electric is sent by wire through a 3 inch PVC pipe to an electric motor number one (1). Motor one (1) spins generator head one (1) by belt, that then supplies 240 volts power to motor two (2). Motor two (2) then spins generator head two (2) by belt that then supplies 240 volts power to motor number three (3). Motor number three then spoins generator head three (3) by belt that produces 240 volts power for motor number four (4) that is connected to generator head one (1) by belt. Motor number one (1) and the portable generator then shut down. Generator heads 1,2 and 3 are are now supplying 240 volts electric to motors 2, 3 and 4 and will keep producing electric until shut down or a part wears out.

B/ Generator head three (3) will supply 240 volts power to a homes electric baseboard heaters for the entire home in winter and air conditioning in summer.

C/ Generator head two (2) will supply 120 volts electric to every electric outlet in the home.

D/ Generator head one (1) will supply 120 volts electric to every overhead light in the home.

E/ Power for electric utilities like water heater, washing machine, clothes dryer, electric stove compactor, dish washer, well pump and septic pump are supplied by generator heads one (1) and or two (2).

F/ Another benefit of this system is if a part wears out only the generator or motor of the worn out part need to be shut down. The portable generator can be started to supply power to keep The two working motors and generator heads operating until the worn out parts are replaced.

### A Brief Summary for Use in a Car.

If this system were adapted to cars, the car could run from L.I., N.Y. to California and back on its own electric without stopping to recharge and at no cost for fuel. The use in a car would need

A/ 4 Electric industrial motors. Either 90 or 100 horsepower.

B/ 3 Electric industrial motors. Either 30 or 40 horsepower

C/ 2 Generator heads either 15,000 or 20,000 watts that produce 240 volts electric.

D/ Waterproof lower body shell to shield the generator heads and motors or waterproof Generator heads and motors.

E/ One small portable electric generator to supply 240 volts electric.

### Brief Explanation of System Operation

A 90 or 100 horsepower motor would power each wheel creating either a 360 or 400 horse-power four (4) wheel drive car. This system car would not peel rubber like a gasoline engine but once up to speed, 70 miles per hour is possible.

Start the car by starting the portable generator. The portable generator now supplies 240 volts power to 30 or 40 hp motor one (1) that is connected to generator head one (1) by Gates belt. Generator head one (1) then supplies 240 volts power to 30 or 40 hp motor two (2) that belt drives generator head two (2). Generator head two (2) now provides 240 volts power to 30 or 40 hp motor three(3) that now takes over from motor one (1) to spin generator head one (1). Motor One (1) and the portable generator then shut down. Generator head one (1) now supplies 240 volts power to both rear wheels and generator two (2) now supplies power to both steerable front wheels. Both generators will supply 120 volts power for accessories like lights radio and backseat TV.

A further benefit of this electric car is. If a generator or electric motor stopped working, the car could still run on two (2) wheels using the portable generator till the motor or generator was Repaired.

### A BRIEF DESCRIPTION OF THE DRAWINGS

The drawings are only a top view to show the portable generator. All four (4) motors and all three (3) generator heads and working parts. To use another side view would only show one half of the system and none of the working parts like belts and pulleys.

FIG. 1 shows the system without part numbers.

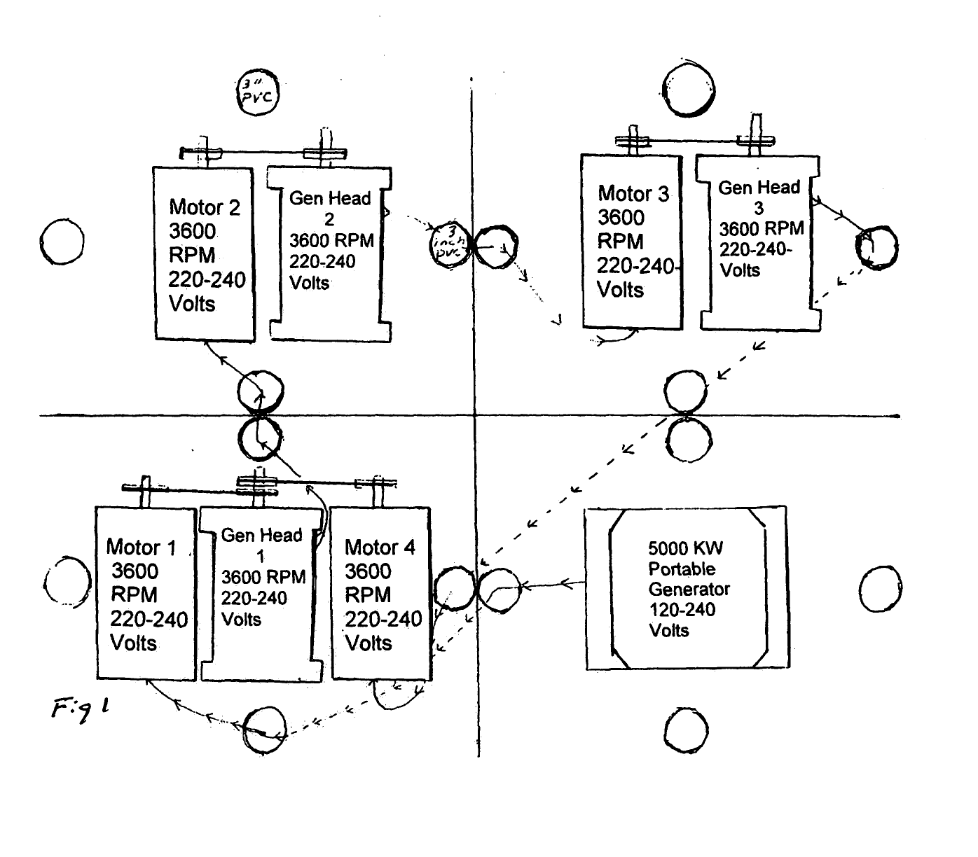

FIG. 2 shows the system with part numbers.

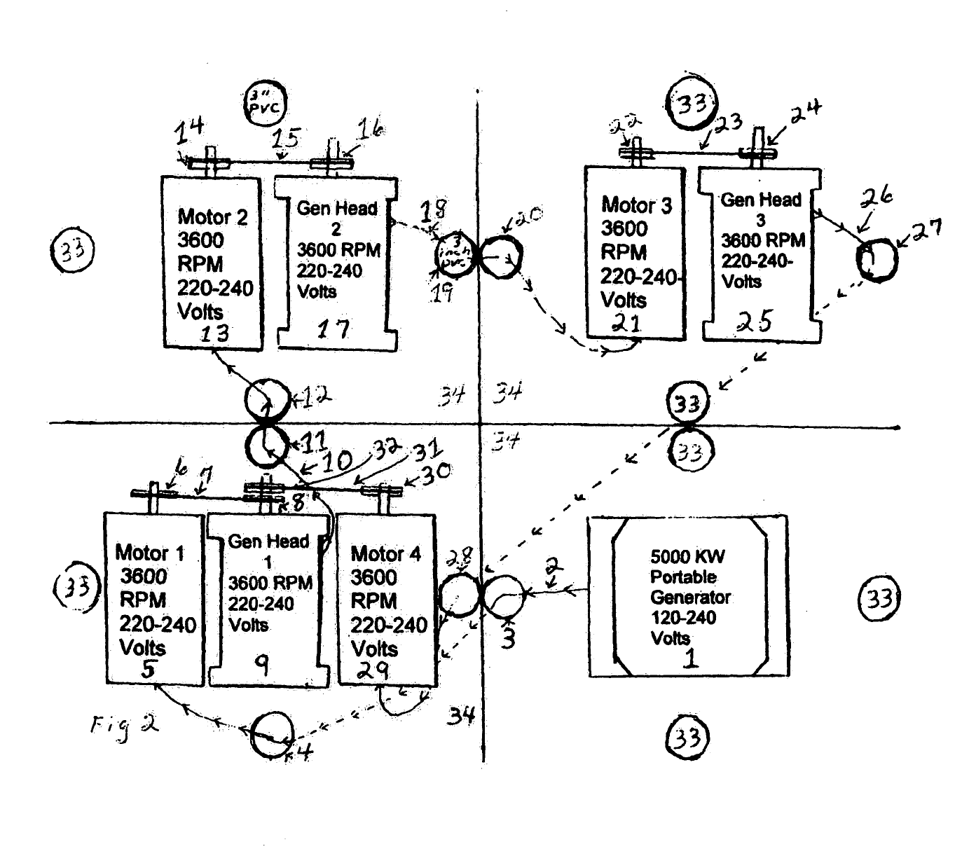

### REFERENCE NUMERALS IN THE DRAWING FIG. 2

1=5000 KW Portable Generator

2=Wire from Portable Generator to Motor one (1)

3=3 inch PVC wire pass through

4=3 inch PVC wire pass through

5=220-240 volt Industrial Motor one (1)

6=Drive Pulley on Motor one (1)

7=Drive Belt Motor one (1) to Gen Head one (1)

8=Pulley on Gen Head one (1)

9=Gen Head one (1) 220-240 & 120 Volts

10=220-240 volt power wire to Motor two (2)

11=3 inch PVC wire pass through

12=3 inch PVC wire pass through

13=220-240 volt Industrial Motor two (2)

14=Drive Pulley on Motor two (2)

15=Drive Belt Motor two (2) to Gen Head two (2)

16=Pulley on Gen Head two (2)

17=Gen Head two (2) 220-240 & 120 Volts

18=220-240 volt power wire to Motor three (3)

19=3 inch PVC wire pass through

20=3 inch PVC wire pass through

21=220-240 volt Industrial Motor three (3)

22=Drive Pulley on Motor three (3)

23=Drive Belt Motor three (3) to Gen Head three (3)

24=Pulley on Gen Head three (3)

25=Gen Head three (3) 220-240 & 120 Volts

26=220-240 volt power wire to Motor four (4)

27=3 inch PVC wire pass through

28=3 inch PVC wire pass through

29=220-240 volt Industrial Motor four (4)

30=Drive Pulley on Motor four (4)

31=Drive Belt Motor four (4) to Gen Head one (1)

32=Drive Pulley Gen Head one (1) from Motor four (4)

33=3 inch PVC wire pass through for expansion to more Motors and Gen Heads

### Instructions for Motor One (1)

Motor one (1) should be installed on a locking sliding plate. This plate to be controlled by a lever. Pushing the lever to the left moves the motor to the left and tightens the drive belt to the generator head. When the motor starts, it will then turn the generator head. After all the generators are generating electric, the portable generator and motor one (1) shut down. To prevent wear on motor one (1) the lever is then pushed to the right to loosen the drive belt from motor one (1) to generator head one (1)

If this invention were used world wide, it would do much to promote world peace. Countries that are now trying to produce atomic power would no longer need to. If they continued with their atomic research ,it would prove that they are really seeking atomic weapons and not atomic power to electrify their countries.

### A DETAILED DESCRIPTION OF MY INVENTION

This invention is intended to replace all commercial electric. The invention can be installed in a newly built home or installed in houses already built. The system of motors uses belts to turn Generator heads is limitless after starting. This description only describes the inventions use With three (3) motors turning three (3) generator heads. With more motors and generator heads The system can replace commercial electric for business, schools and other large buildings. A portable electric generator (1) powered by either gas or propane will start the system. Once the portable generator has started, it will send 240 volt electric by wire (2) through a system of 3 inch PVC pipe (3&4) to motor one (5) that motor in turn will spin pulley (6). A belt connects pulley (6) to a pulley (8) on generator head (9). Generator head (9) now produces 240 volt electric that is sent by wire (10) through PVC pipe (11 & 12) to motor two (13). Motor two (13) now spins pulley (14) that is connected by belt (15) to pulley (16) on generator head two (17). Generator head two (17) now will supply 240 volts electric power by wire (18) through PVC pipe (19 & 20) to motor three (21). Motor three (21) will energize and spin pulley (22) that is connected by belt (23) to pulley (24) that will in turn spin generator head three (25). Generator head three (25) will now supply 240 volts of electric by wire (26) through PVC Pipes (27 & 28) to motor four (29). Motor four (29) then is energized and turns pulley (30) that is connected by belt (31) to pulley (32) on generator head one (9). Motor four (29) now becomes the primary energizer of generator head one (9). The portable generator will then shut down taking power from motor one (5) that also stops working. The system is now powered by three generators supplying 240 volts electric to three motors that are energizing the three generators without using outside commercial electric.

Having described my invention on previous pages, I claim that I am the sole inventor of this system to replace a homes commercial power with a power system using no outside power or batteries.

What I claim is:

1/ The system is a self running Home Electrical Generation System.
The system will run once started without outside electric.
A/ A 4 section pad made from cement to be sized according to the size of the motors and generator heads.
B/ The system uses one (1) portable generator that will run on gasoline or propane.
C/ Four (4) 30 horsepower 240 volt industrial electric motors running at 3600 RPM.
D/ Three (3) 15,000 or 20,000 watt generator heads that produce 240 and 120 volts electric running at 3600 RPM.
E/ Four (4) lock able steel air cooling cabinets sized to cover the motors and generator heads.

2/ The system is started by the portable generator that then supplies electric to the next motor that then supplies belt drive to the next generator.
After motors 2, 3 and 4 are spinning generator heads 1,2 and 3 the system will supply its own electric until it is either shut down by motor switches or a part ceases to work.

3/ The portable generator and motor one(1) are only used to start the system. They both shut down after the other three(3) motors and generator heads are working and producing electric.
I further claim that unlike most present systems, this system uses no batteries and can be installed in new housing or present houses, office buildings, factories, schools, hospitals and stores by adding more motors and generator heads.
